(19) United States
(12) Patent Application Publication
(10) Pub. No.: US 2026/0316470 A1
(43) Pub. Date: Oct. 15, 2026

(54) PRINTER

(71) Applicant: BROTHER KOGYO KABUSHIKI KAISHA, Nagoya (JP)

(72) Inventors: Narumi TODA, Nagoya (JP); Shohei KURIYAMA, Inazawa (JP); Yuto KIMATA, Nagoya (JP)

(21) Appl. No.: 19/462,747

(22) Filed: Jan. 28, 2026

(30) Foreign Application Priority Data
Jan. 31, 2025 (JP) 2025-015244

(51) Int. Cl. B41J 29/393; B41J 29/13; H01M 50/202; H01M 50/262; H01M 50/271

(52) U.S. Cl. CPC B41J 29/393; B41J 29/13; H01M 50/202; H01M 50/262; H01M 50/271

(57) ABSTRACT

A printer includes a print head, a housing, and a battery housing portion. The print head extends in a main scanning direction. The housing including a first wall, a second wall, a lower wall, and a housing space. The first wall extends in a direction that crosses the main scanning direction. The second wall opposes the first wall. The lower wall connects the first wall and the second wall with each other in the main scanning direction. The housing space is defined between the first wall and the second wall and configured to house a print medium. The battery housing portion is included in the first wall of the housing and configured to house a coin cell battery.

### REFERENCE TO RELATED APPLICATIONS

This application claims priority from Japanese Patent Application No. 2025-015244 filed on Jan. 31, 2025. The entire content of the priority application is incorporated herein by reference.

### BACKGROUND ART

A bottom surface of a known printer includes a battery housing portion for a coin cell battery. The coin cell battery is used to supply power to the printer for continuing some operations when the printer is cut off from a main power source that is required for major operations, printing, for example, of the printer. For example, the battery provides the power for maintaining an RTC (Real Time Clock) function of the printer.

### SUMMARY

The battery housing portion of the above-described known printer is normally covered by a cover member. To replace the coin cell battery, a user of the printer places the printer such that the bottom surface faces upward and remove the cover member. The replacement of the coin cell battery may be thus troublesome for the user.

Embodiments of the broad principles derived herein provide a printer that contributes to easier replacement of a coin cell battery with simple operations of a user, as compared to the known printer.

Embodiments provide a printer that includes a print head, a housing, and a battery housing portion. The print head extends in a main scanning direction. The housing including a first wall, a second wall, a lower wall, and a housing space. The first wall extends in a direction that crosses the main scanning direction. The second wall opposes the first wall. The lower wall connects the first wall and the second wall with each other in the main scanning direction. The housing space is defined between the first wall and the second wall and configured to house a print medium. The battery housing portion is included in the first wall of the housing and configured to house a coin cell battery.

The first wall of the housing of the printer includes the battery housing portion. For a user of the printer, the first wall is more easily accessible than the bottom wall. Therefore, the printer contributes to easier replacement of the coin cell battery with simple operations of a user, as compared to a known printer in which a lower wall of a housing includes a battery housing portion.

### BRIEF DESCRIPTION OF DRAWINGS

FIG. 1A is a perspective view of a printer with a cover at a closed position, covering a housing space of the housing. FIG. 1B is a perspective view of the printer with the cover at an open position, opening the housing space of the housing.

FIG. 2 is a plan view of the printer with the cover at the open position.

FIG. 3A is a left side view of the printer with the cover at the open position and a holder in a battery housing portion. FIG. 3B is a left side view of the printer with the cover at the open position and the holder outside of the battery housing portion.

FIG. 4 is a partial cross-sectional view of the printer with the holder at an attached position, taken along line A-A in FIG. 1A as viewed in a direction of arrows.

FIG. 5 is a plan view of another printer with the cover at the open position.

FIGS. 6A, 6B and 6C are cross-sectional views each showing a lid and a battery housing portion of the printer, taken along line B-B in FIG. 5 as viewed in a direction of arrows.

FIGS. 7A, 7B and 7C are right side views each showing the lid and the battery housing portion.

FIG. 8A is a perspective view showing yet another printer and a battery base removed from the printer. FIG. 8B is a perspective view of the printer and the battery base attached to the printer.

FIG. 9 is a perspective view showing the printer with a lower wall facing upward and the battery base with an upper wall facing upward.

FIG. 10 is a cross-sectional view taken along line C-C in FIG. 8A as viewed in a direction of arrows.

FIG. 11 is another perspective view of the printer and the battery base attached to the printer.

### DESCRIPTION

A structure of a printer 1 according to an embodiment of the present disclosure is described below, with reference to the drawings. Left, right, front, rear, top and bottom shown by arrows in the drawings are used in the following description.

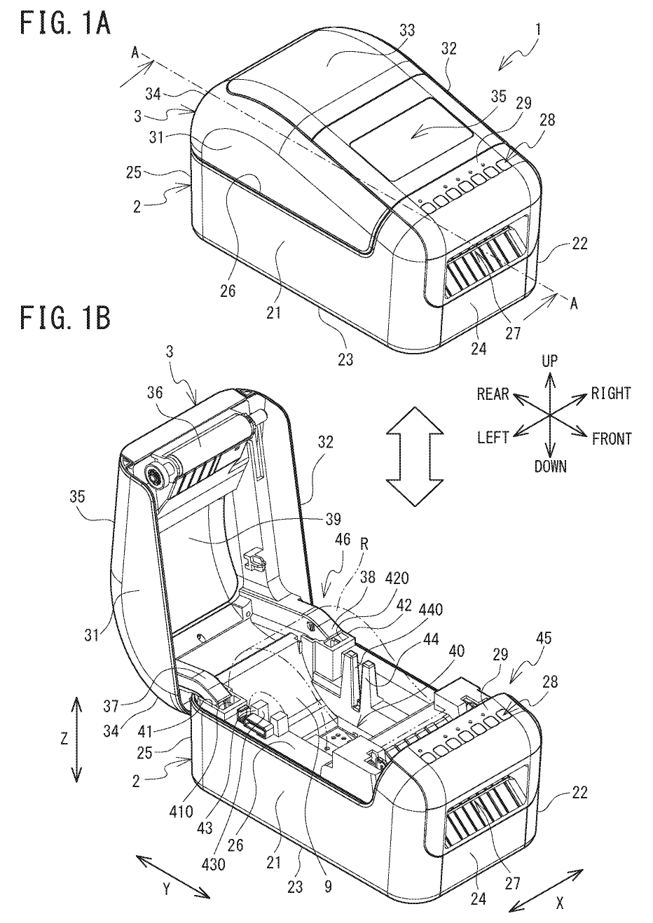

As shown in FIGS. 1A to 4, the printer 1 is a thermal printer that includes a print head 30. The print head 30 is configured to print an image that is indicated by print data. The print data may be transmitted by wire or wirelessly from an external device, such as a PC (personal computer). The printer 1 is a mobile printer that can be carried by a user of the printer 1.

The printer 1 includes a housing 2 and a cover 3. The housing 2 is generally a box having an open upper end. The housing 2 serves as a lower part of the printer 1. The housing 2 includes a first wall 21, a second wall 22, a lower wall 23, a front wall 24, a rear wall 25, an upper wall 29 and an inner wall 9. The printer 1 is normally placed on a flat surface, such as a top surface of a desk, in an orientation in which the lower wall 23 serves as a bottom surface of the printer 1.

The first wall 21 extends in a direction that crosses a main scanning direction that is indicated by an arrow X. The main scanning direction is a direction in which the print head 30 extends. The main scanning direction in the present embodiment defines a left-right direction of the printer 1. The first wall 21 in the present embodiment extends in a sub scanning direction that is perpendicular to the main scanning direction. The sub scanning direction, which is indicated by an arrow Y, defines a front-rear direction of the printer 1. The first wall 21 extends upward from a left end of the lower wall 23. The first wall 21 has an opposing surface 26 that opposes or faces the cover 3 that is at a closed position shown in FIG. 1A.

The second wall 22 opposes or faces the first wall 21. The second wall 22 in the present embodiment extends parallel to the first wall 21. The second wall 22 extends upward from a right end of the lower wall 23.

The lower wall 23 connects the first wall 21 and the second wall 22 to one another in the main scanning direction. A length of the lower wall 23 in the main scanning direction is shorter than a length of the lower wall 23 in the sub scanning direction.

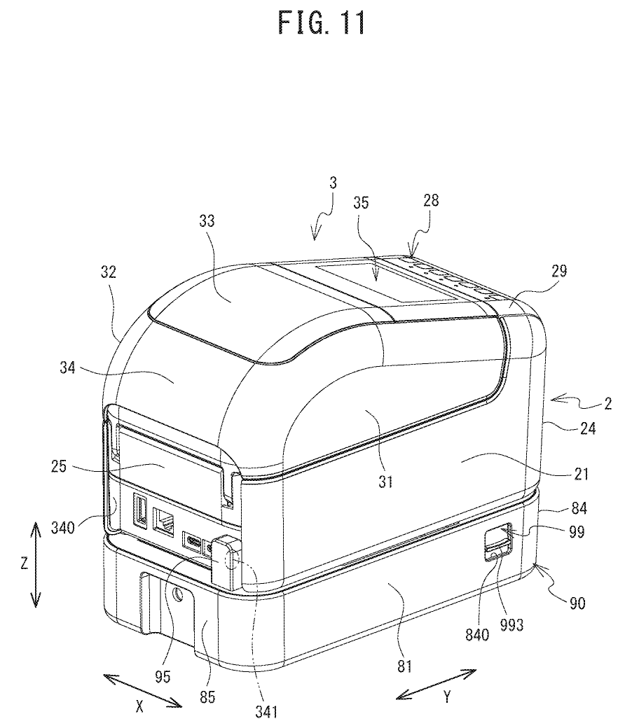

The front wall 24 extends in the main scanning direction. The front wall 24 extends upward from a front end of the lower wall 23. The front wall 24 has an output slot 27. The output slot 27 is rectangular elongated in the left-right direction and positioned in an upper portion of the front wall 24. The rear wall 25 opposes or faces the front wall 24 and extends in the main scanning direction. The rear wall 25 extends upward from a rear end of the lower wall 23. The rear wall 25 has a DC (Direct Current) port 341 shown in FIG. 11. An AC (Alternating Current) adapter configured to supply power to the printer 1 may be connected to the DC port 341.

The upper wall 29 extends rearward from an upper end of the front wall 24. A length of the upper wall 29 in the sub scanning direction is shorter than a half of a length of the upper wall 29 in the main scanning direction. The inner wall 9 is a plate member. A rear portion of the inner wall 9 is curved in an arc in a downwardly convex manner.

The housing 2 includes a housing space 40 that is defined between the first wall 21 and the second wall 22. The housing space 40 is configured to house or accommodate a print medium R. The first wall 21 defines a left end of the housing space 40. The second wall 22 defines a right end of the housing space 40. The inner wall 9 defines a front end, a rear end, and a lower end of the housing space 40. The print medium R of the present embodiment is, for example, thermal paper that is wound into a roll. The print medium R is subjected to printing by the print head 30 and then discharged outside of the printer 1 through the output slot 27.

The cover 3 is supported on the housing 2 to be pivotable to a closed position shown in FIG. 1A and an open position shown in FIG. 1B. The cover 3 at the closed position closes or covers the housing space 40. The cover 3 at the open position opens the housing space 40 or allows the housing space 40 to be open to an outside of the printer 1. In a case where the cover 3 is at the closed position, an upper surface of the cover 3 slopes downward as the cover 3 extends forward. The structure of the cover 3 is described below with reference to the cover 3 disposed at the closed position.

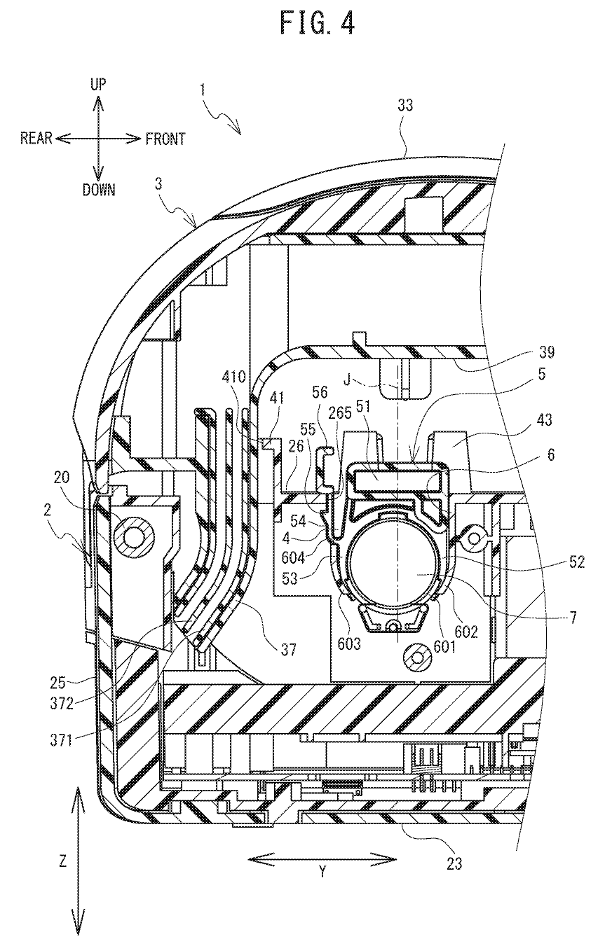

The cover 3 is supported at one of two opposite end portions of the housing 2 in the sub scanning direction, i.e., the front-rear direction, to be pivotable about a pivot shaft 20 shown in FIG. 4. The sub scanning direction is perpendicular to the main scanning direction and a perpendicular direction that is perpendicular to the opposing surface 26. The perpendicular direction in the present embodiment is indicated by an arrow Z and defines an up-down direction of the printer 1. In the present embodiment, the two opposite end portions are a front end portion 45 and a rear end portion 46. The one of the two opposite end portions of the housing 2 in the sub scanning direction is the rear end portion 46 of the housing 2. The pivot shaft 20 extends in the main scanning direction at the rear end portion 46 of the housing 2.

The cover 3 includes a left wall 31, a right wall 32, an upper wall 33, a rear wall 34, an inner wall 39, and wire protection portions 37, 38. The left wall 31 extends in the sub scanning direction. The left wall 31 extends downward from a left end of the upper wall 33. A lower end of the left wall 31 of the cover 3 abuts the opposing surface 26 of the first wall 21 of the housing 2.

The right wall 32 opposes or faces the left wall 31. The right wall 32 in the present embodiment extends parallel to the left wall 31. The right wall 32 extends downward from a right end of the upper wall 33. A lower end of the right wall 32 of the cover 3 abuts an upper surface of the second wall 22 of the housing 2.

The upper wall 33 connects the left wall 31 and the right wall 32 to one another in the main scanning direction. A front end of the upper wall 33 of the cover 3 abuts a rear end of the upper wall 29 of the housing 2. The rear wall 34 curves downward in an arc from a rear end of the upper wall 33. A lower end of the rear wall 34 of the cover 3 abuts an upper surface of the rear wall 25 of the housing 2. The inner wall 39 extends in a horizontal direction below the upper wall 33.

The wire protection portion 37 extends downward from a left rear portion of the inner wall 39. A lower end portion of the wire protection portion 37 is curved rearward. The wire protection portion 37 has insertion holes 371, 372 that allow passage of wires. The insertion holes 371, 372 extend through the wire protection portion 37, curving along the wire protection portion 37.

The wire protection portion 38 extends downward from a right rear portion of the inner wall 39. A lower end portion of the wire protection portion 38 is curved rearward. The wire protection portion 38 has insertion holes that allow passage of the wires. The wires are, for example, disposed for the purpose of supplying power to an electrical component that is disposed in or on the cover 3. A display 35 is an example of the electrical component.

The housing 2 of the printer 1 includes the print head 30, an operation portion 28, a holder 5, a battery housing portion 6, a lock portion 55, an unlock portion 56, projections 41, 42, and medium support portions 43, 44.

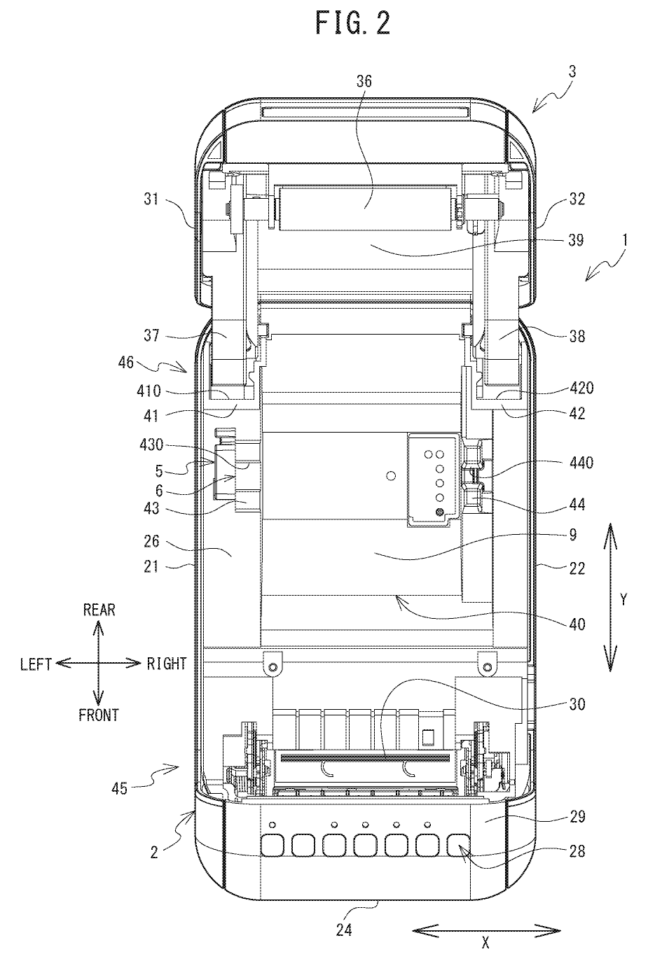

As shown in FIG. 2, the print head 30 extends in the main scanning direction. The print head 30 in the present embodiment is a thermal head that includes heating elements that are aligned in the main scanning direction. The print head 30 is configured to thermally print characters on the thermal paper, the print medium R, under control of an electronic circuit board. The electronic circuit board is disposed in a space between the inner wall 9 and the lower wall 23 of the housing 2.

As shown in FIG. 1A, the operation portion 28 is disposed on an upper surface of the upper wall 29. The operation portion 28 includes switches and used for inputting various instructions to the printer 1.

As shown in FIGS. 1B to 4, the battery housing portion 6 is configured to house or accommodate a coin cell battery 7. Hereafter, the coin cell battery 7 is simply referred to as a battery 7. The first wall 21 includes the battery housing portion 6. In the present embodiment, the battery housing portion 6 is disposed in the opposing surface 26. The battery housing portion 6 is located frontward of the projection 41 and leftward of the medium support portion 43. The battery housing portion 6 is a recess that is disposed in the first wall 21 and recessed downward from the opposing surface 26. The battery housing portion 6 is a recess having a shape that corresponds to or conforms to a shape of the holder 5 in a predetermined first orientation.

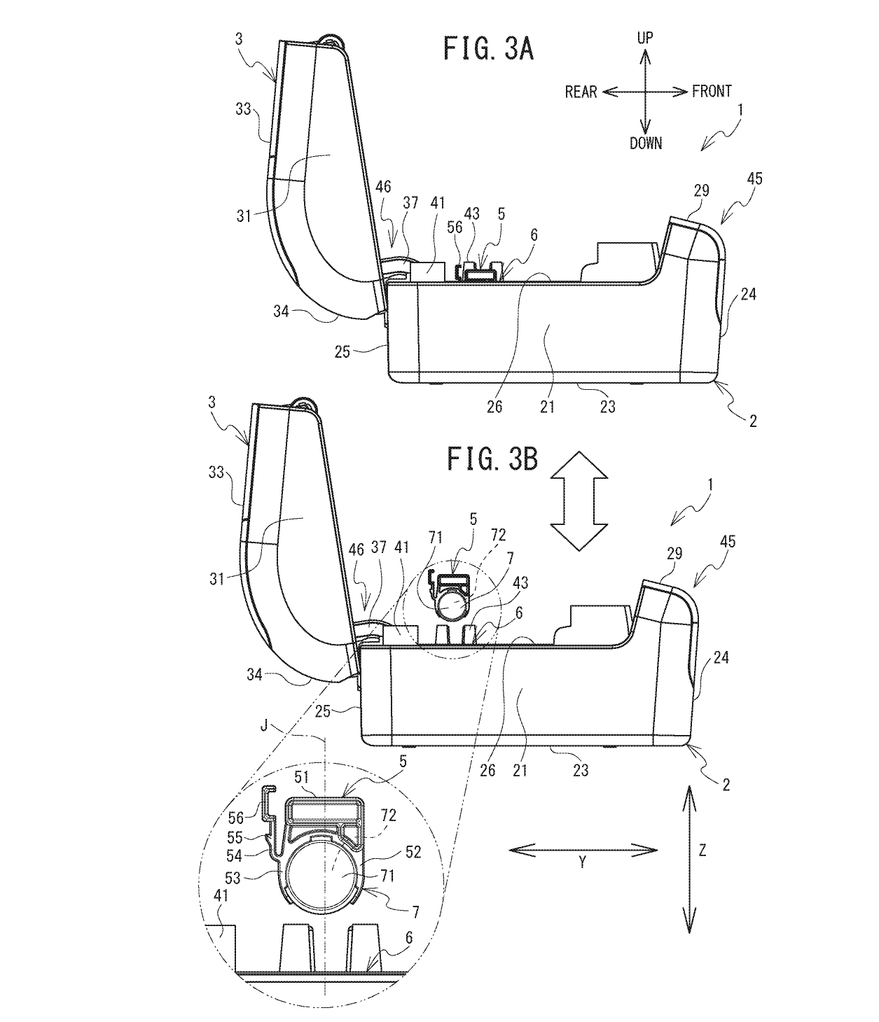

As shown in FIGS. 3A to 4, when the holder 5 is in the predetermined first orientation, a hook 54 is disposed at one specific direction with respect to a lid 51, specifically, at rearward of the lid 51, in the sub scanning direction, i.e., in the front-rear direction. The battery housing portion 6, i.e., the recess, houses the holder 5 to be slidable in the perpendicular direction, i.e., in the up-down direction.

As shown in FIG. 4, The battery housing portion 6 includes a first wall 602, a bottom wall 601, a second wall 603, and a hole 604. The first wall 602 extends downward from the opposing surface 26. A lower end portion of the first wall 602 is curved rearward. The bottom wall 601 is curved in an arc along an outer peripheral surface of a lower portion of the battery 7. A front end portion of the bottom wall 601 abuts a rear surface of the lower end portion of the first wall 602.

The second wall 603 opposes or faces the first wall 602 and extends in the perpendicular direction. A lower end portion of the second wall 603 is curved forward. A rear end portion of the bottom wall 601 abuts a front surface of the lower end portion of the second wall 603. The hole 604 is disposed between an upper end of the second wall 603 and an engagement portion 265. The engagement portion 265 is located rearward of the battery housing portion 6. The engagement portion 265 is a portion of the first wall 21 that is in contact with the opposing surface 26 and the battery housing portion 6.

The holder 5 is configured to removably hold the battery 7. The holder 5 is made from elastic plastic resin. The battery 7 supplies power for memory backup, continued operation of a built-in clock, and maintaining settings, for example. The holder 5 includes the lid 51, arms 52, 53, and the hook 54. The holder 5 has a shape that is asymmetric with respect to a virtual axis J that passes through a center of the lid 51 in the sub scanning direction and extends in the perpendicular direction. The lid 51 closes the battery housing portion 6 when the holder 5 is disposed in the battery housing portion 6.

The arms 52, 53 are connected to the lid 51. The arm 52 extends downward from a front end of the lid 51. A lower end portion of the arm 52 is curved rearward. A rear surface of the arm 52 has a groove that is recessed forward. The groove has an arc shape that fits or conforms to the outer peripheral surface of the battery 7.

The arm 53 extends downward from a rear end of the lid 51. A lower end portion of the arm 53 is curved forward. A front surface of the arm 53 has a groove that is recessed rearward. The groove has an arc shape that fits or conforms to the outer peripheral surface of the battery 7. The rear end of the arm 53 is located rearward of a rear end of the lid 51.

The arms 52, 53 are configured to hold the battery 7 in an orientation in which electric terminal surfaces 71, 72 of the battery 7 are perpendicular to the main scanning direction. The electric terminal surfaces 71, 72 herein refer to two opposite flat surfaces of the battery 7 that serve as electric terminals. The electric terminal surface 71 that serves as a negative terminal is hereinafter also referred to as a negative terminal surface 71, and the electric terminal surface 72 that serves as a positive terminal is hereinafter also referred to as a positive terminal surface 72. Specifically, the arms 52, 53 are configured to hold the battery 7 such that the negative terminal surface 71 faces leftward and the positive terminal surface 72 faces rightward. In a case where the battery 7 is held by the arms 52, 53, the outer peripheral surface of the battery 7 is disposed in the groove of the rear surface of the arm 52 and the groove of the front surface of the arm 53. The battery 7 is held by and between the arms 52, 53 in the front-rear direction.

The hook 54 extends upward and rearward from a portion of the arm 53 that is above a center of the arm 53 in the up-down direction. In a case where the holder 5 is at an attached position shown in FIG. 4, a lower end of the hook 54 abuts the hole 604, i.e., an upper end of the second wall 603. In the case where the holder 5 is at the attached position, the hook 54 is elastically deformed and slightly deflected or bent forward. A rear surface of the hook 54 abuts the opposing surface 26. The holder 5 is positioned relative to the battery housing portion 6 in the front-rear direction, owing to elastic deformation of the hook 54.

The lock portion 55 restricts movement of the holder 5 in the perpendicular direction when the holder 5 is in the battery housing portion 6, i.e., the recess. The lock portion 55 is disposed in a direction parallel to the sub scanning direction, i.e., rearward, relative to the virtual axis J. The lock portion 55 and the unlock portion 56 are disposed between the pivot shaft 20 and the virtual axis J in the sub scanning direction.

The lock portion 55 is a projection that projects rearward from the rear surface of the hook 54. The lock portion 55 is triangular shape in a side view. A rear surface of the lock portion 55 slopes forward as the lock portion 55 extends downward. In the case where the holder 5 is at the attached position shown in FIG. 4, the lock portion 55 is located below the opposing surface 26 and is engaged with the hole 604 of the battery housing portion 6. In a case where the user tries to move the holder 5 upward from the attached position, the lock portion 55 comes into contact with the engagement portion 265, so that upward movement of the holder 5 in the perpendicular direction is prevented.

The unlock portion 56 is configured to release or unlock the holder 5 locked by the lock portion 55. The unlock portion 56 is connected to un upper end of the hook 54. The unlock portion 56 has a C shape that opens forward in a left side view.

In the case where the holder 5 is at the attached position shown in FIG. 4, the unlock portion 56 is located above the opposing surface 26. The unlock portion 56 is between the lid 51 of the holder 5 and the projection 41 in the sub scanning direction. An upper end of the unlock portion 56 is located above an upper end of the lid 51. The upper end of the unlock portion 56 is located below an upper end of the projection 41.

The projection 41 is disposed on a rear end portion of the opposing surface 26 of the first wall 21. The projection 41 is between the unlock portion 56 and the pivot shaft 20 in the sub scanning direction of the printer 1. The projection 41 projects further from the opposing surface 26 in the perpendicular direction than the unlock portion 56. The upper end of the projection 41 is located above the upper end of the unlock portion 56 that is attached to the battery housing portion 6. The projection 41 has a hole 410 that extends through the projection 41 in the up-down direction. The wire protection portion 37 of the cover 3 is inserted in the hole 410.

The projection 42 is disposed on a rear end portion of the upper surface of the second wall 22. In the front-rear direction, the projections 41, 42 are disposed at the same location. The projection 42 has a hole 420 that extends through the projection 42 in the up-down direction. The wire protection portion 38 of the cover 3 is inserted in the hole 420. The lower end portions of the wire protection portions 37, 38 are each curved rearward. Therefore, when the cover 3 is at the open position, no interference occurs between the projection 41 and the wire protection portion 37, as well as between the projection 42 and the wire protection portion 38.

The medium support portions 43, 44 are configured to support a cassette that holds the roll of the print medium R. The medium support portion 43 has a recess 430 that is U-shaped in the side view. The medium support portion 44 has a recess 440 that is U-shaped in the side view. The medium support portion 43 supports a left end portion of the cassette, while the medium support portion 44 supports a right end portion of the cassette.

As shown in FIGS. 1A to 2, the cover 3 of the printer 1 includes a platen roller 36 and the display 35. The platen roller 36 is located above the print head 30 when the cover 3 is at the closed position. The platen roller 36 and the print head 30 hold or nip the print medium R from above and below. The platen roller 36 rotates in response to driving of a motor to thereby convey or feed the print medium R while nipping the print medium R with the print head 30.

The display 35 is disposed on a front portion of an upper surface of the cover 3. The display 35 is configured to display various images. The display 35 is, for example, a liquid crystal display having a rectangular shape in a plan view.

Operations for replacing the battery 7 for the printer 1 are described with reference to FIGS. 3A to 4. The user of the printer 1 first moves the unlock portion 56 forward. In response to the forward movement of the unlock portion 56, the hook 54 is elastically deformed to be bent forward, so that the lock portion 55 is disengaged from the engagement portion 265. The user moves the holder 5 upward while keeping the position of the unlock portion 56 moved forward.

The user moves the battery 7 rearward, leftward or rightward relative to the holder 5 and removes the battery 7 from the holder 5. The arms 52, 53 are elastically deformed in response to the rearward, leftward or rightward movement of the battery 7 to release the battery 7.

The user places a new battery 7 between the arms 52, 53 of the holder 5. Upon receiving the battery 7 between the arms 52, 53, the arms 52, 53 are elastically deformed to hold the battery 7 from front and rear sides of the battery 7. The battery 7 is held by the arms 52, 53 from above in the orientation in which the negative terminal surface 71 faces leftward and the positive terminal surface 72 faces rightward. The grooves of the arms 52, 53 are shaped to conform to the outer peripheral surface of the battery 7. Therefore, when the battery 7 is oriented such that the positive terminal surface 72 faces leftward and the negative terminal surface 71 faces rightward, the battery 7 cannot be held between the arm 52 and arm 53.

The user places the holder 5 in the predetermined first orientation in which the hook 54 and thus the lock portion 55 and the unlock portion 56 are disposed between the lid 51 and the pivot shaft 20 in the sub scanning direction, i.e., the front-rear direction. The user moves the holder 5 downward relative to the battery housing portion 6, while maintaining the holder 5 in the first orientation, until the battery 7 is placed at the attached position. While the holder 5 is moved downward toward the attached position, the engagement portion 265 comes into contact with the hook 54 and the lock portion 55. Upon contact with the engagement portion 265, the hook 54 is elastically deformed to move forward relative to the engagement portion 265. In a case where the holder 5 is moved further downward, the engagement portion 265 is placed between the lock portion 55 and the unlock portion 56. The hook 54 is kept to be elastically deformed such that the hook 54 is bent slightly forward.

In the case where the holder 5 is at the attached position, a front surface of the arm 52 of the holder 5 abuts a rear surface of the first wall 602, and a rear surface of the arm 53 of the holder 5 abuts a front surface of the second wall 603. A lower portion of the battery 7 that is held by the holder 5 abuts an upper surface of the bottom wall 601. The lower end of the hook 54 abuts a lower end of the hole 604, i.e., the upper end of the second wall 603. The lock portion 55 is disposed below the opposing surface 26. The unlock portion 56 is disposed above the opposing surface 26.

The holder 5 assumes a second orientation when the holder 5 in the first orientation is rotated by 180 degrees about the virtual axis J. In a case where the holder 5 is in the second orientation, the holder 5 interferes with the battery housing portion 6 and thus insertion of the holder 5 into the battery housing portion 6, i.e., a recess, is prevented. In the case where the holder 5 is in the second orientation, the hook 54 and thus the lock portion 55 and the unlock portion 56 are not disposed between the lid 51 and the pivot shaft 20 in the sub scanning direction, and disposed frontward of the lid 51 in the front-rear direction. More specifically, when the user tries to insert the holder 5 in the second orientation into the battery housing portion 6, the first wall 602 of the battery housing portion 6 interferes with the hook 54. Therefore, the user cannot attach the holder 5 to the battery housing portion 6 when the holder 5 is in the second orientation.

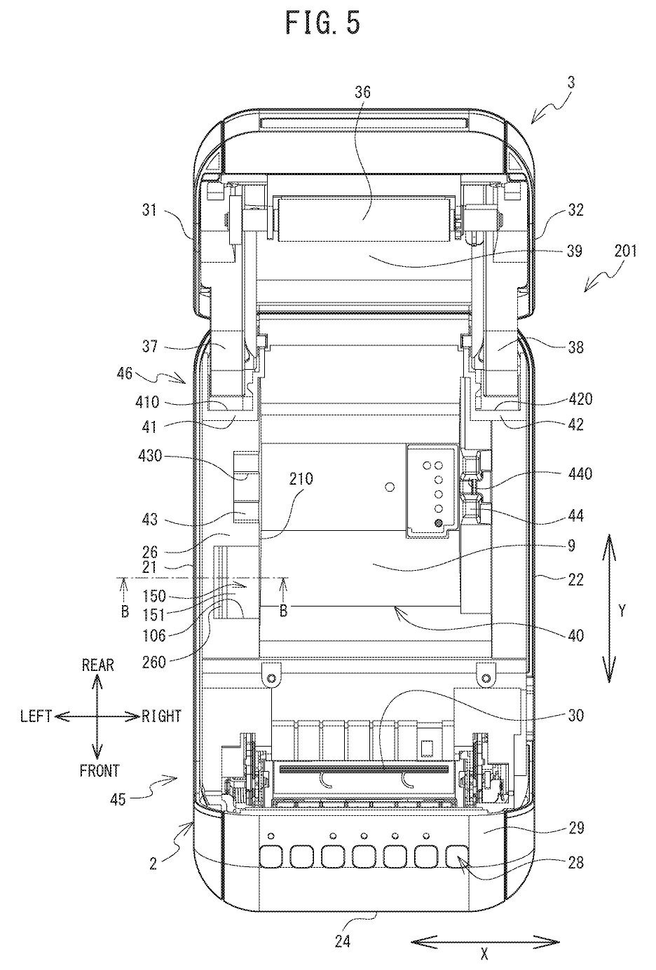

A printer 201 according to a modified embodiment is described below, with reference to FIGS. 5 to 7C. In FIG. 5, same numerals are assigned to elements or structures that are substantially the same as those of the printer 1 according to the above-described embodiment. As shown in FIG. 5, the printer 201 differs from the printer 1 in that the printer 201 includes a battery housing portion 106 and a lid 150, in place of the holder 5 and the battery housing portion 6. The different elements or structures are mainly described below, while description of the elements or structures that are substantially the same as those of the printer 1 are omitted or simplified.

The printer 201 of the modified embodiment shown in FIG. 5 includes the print head 30, the housing 2, the cover 3, the battery housing portion 106, an unlock portion 260 and the lid 150. The cover 3 is supported by the housing 2 to be pivotable to the closed position at which the cover 3 closes the housing space 40, and the open position at which the cover 3 opens the housing space 40. The first wall 21 has the opposing surface 26 that opposes or faces the cover 3 at the closed position.

The battery housing portion 106 is configured to house or accommodate the battery 7. The first wall 21 includes the battery housing portion 106. The battery housing portion 106 of the modified embodiment is disposed in the opposing surface 26. Specifically, the first wall 21 includes the battery housing portion 106 that is disposed as a recess recessed downward from the opposing surface 26.

More specifically, the battery housing portion 106 is a recess that is recessed downward from the opposing surface 26 and recessed leftward from a right surface 210 of the first wall 21. The battery housing portion 106 is disposed frontward of the projection 41 and the medium support portion 43 and rearward of the upper wall 29 in the sub scanning direction, i.e., the front-rear direction.

The battery housing portion 106 includes grooves 161, 162 each extending in the perpendicular direction, i.e., the up-down direction. Specifically, a rear wall 107 of the battery housing portion 106 has the groove 161 that is recessed rearward from a front surface of the rear wall 107. A front wall 108 of the battery housing portion 106 has the groove 162 that is recessed forward from a rear surface of the front wall 108. A width of the grooves 161, 162 in the main scanning direction, i.e., the left-right direction is slightly larger than a thickness of the battery 7.

The groove 161 opposes or faces the groove 162. A distance between a rear end of the groove 161 and a front end of the groove 162 is slightly larger than a diameter of the battery 7. The grooves 161, 162 are configured to support the battery 7 to be slidable in the perpendicular direction that is perpendicular to the opposing surface 26. The grooves 161, 162 are also configured to support the battery 7 in an orientation in which the electric terminal surfaces 71, 72 of the battery 7 are perpendicular to the main scanning direction. More specifically, the grooves 161, 162 are configured such that the battery 7 in a first orientation enters the grooves 161, 162 from above. In the case where the battery 7 is in the first orientation, the negative terminal surface 71 faces leftward and the positive terminal surface 72 faces rightward. The grooves 161, 162 are shaped to fit or conform to the outer peripheral surface of the battery 7. Therefore, when the battery 7 is in a second orientation, in which the positive terminal surface 72 faces leftward and the negative terminal surface 71 faces rightward, the battery 7 cannot be inserted in the grooves 161, 162.

The first wall 21 includes a recess 263 that is recessed downward from the opposing surface 26. The recess 263 is disposed leftward of the battery housing portion 106. The recess 263 communicates with the battery housing portion 106. The battery housing portion 106 is longer or deeper than the recess 263 in the perpendicular direction.

The unlock portion 260 extends upward from a bottom surface of the recess 263. A projection 261 projects rightward from a right surface of the unlock portion 260. The unlock portion 260 is made from plastic resin and elastically deformable.

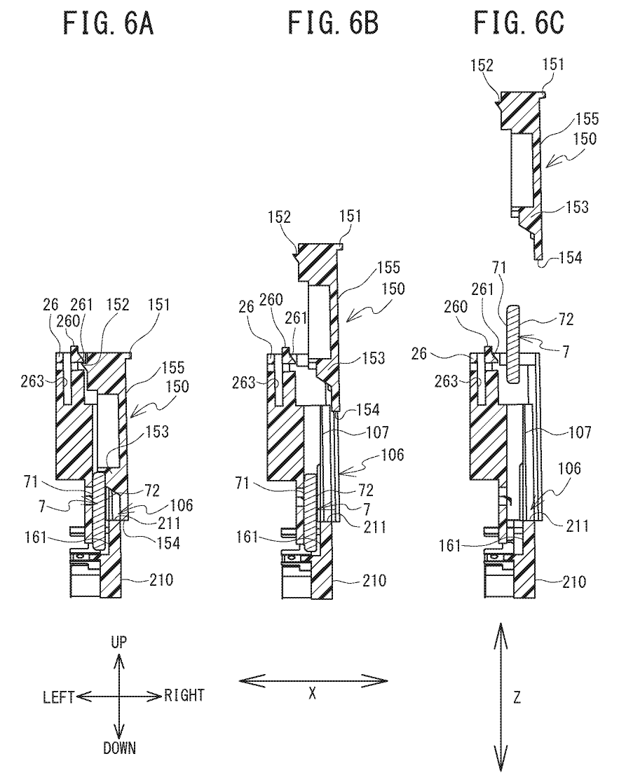

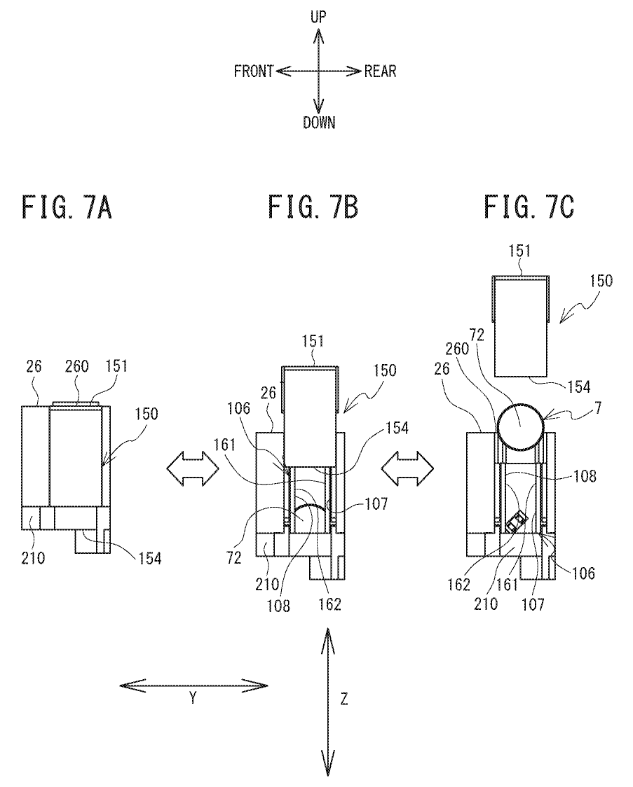

The lid 150 is configured to close or cover the battery housing portion 106 with the battery 7 disposed in the battery housing portion 106. The lid 150 includes an upper wall 151, a right wall 155, a lock portion 152 and an abutment portion 153. The upper wall 151 extends in the horizontal direction when the lid 150 closes the battery housing portion 106. The upper wall 151 is rectangular in the plan view. The right wall 155 extends downward from a portion of the upper wall 151 that is slightly leftward of a right end of the upper wall 151. The right wall 155 is rectangular in a right side view. In a case where the lid 150 is at an attached position shown in FIGS. 6A and 7A, a lower end 154 of the right wall 155 abuts an end portion 211 of the first wall 21. The end portion 211 is a portion of the first wall 21 that is in contact with the battery housing portion 106 and the right surface 210 of the first wall 21.

The lock portion 152 extends leftward from a left surface of the upper wall 151. The lock portion 152 is triangular in a front view. A left surface of the lock portion 152 slopes rightward as the lock portion 152 extends downward. In a case where the lid 150 is at the attached position shown in FIGS. 6A and 7A, the lock portion 152 is located below the opposing surface 26 and is engaged with the projection 261. In a case where a user of the printer 201 moves the lid 150 upward from the attached position, the lock portion 152 comes into contact with the projection 261, so that upward movement of the lid 150 in the perpendicular direction is prevented.

The abutment portion 153 projects leftward from the right wall 155. In a case where the lid 150 is at the attached position shown in FIGS. 6A and 7A, the abutment portion 153 abuts an upper end and a right surface of the battery 7. The abutment portion 153 thus positions the battery 7 in the perpendicular direction and the main scanning direction.

Operations for replacing the battery 7 for the printer 201 of the modified embodiment are described with reference to FIGS. 6A to 7C. The user moves the unlock portion 260 leftward from an initial position of the unlock portion 260 shown in FIGS. 6A and 7A, so that the projection 261 is disengaged from the lock portion 152. As shown in FIGS. 6B and 7B, the user then holds a right end of the upper wall 151 of the lid 150 and slides the lid 150 upward and removes the lid 150 from the first wall 21. Further, the user slides the battery 7 upwards with an operation element, a finger of the user, for example, and removes the battery 7 from the battery housing portion 106.

As shown in FIGS. 6C and 7C, the user engages another battery 7 with the grooves 161, 162 of the battery housing portion 106 and slides the battery 7 downward along the grooves 161, 162. As shown in FIGS. 6B and 7B, the user then slides the lid 150 downward to be attached to the battery housing portion 106. As shown in FIGS. 6A and 7A, the lid 150 is thus placed at the attached position and closes the battery housing portion 106. The projection 261 and the lock portion 152 of the lid 150 are engaged with each other.

More specifically, in the perpendicular direction, i.e., the up-down direction, an upper surface of the upper wall 151 of the lid 150 is disposed at the same location, i.e., at the same height level, as the opposing surface 26. A right surface of the right wall 155 of the lid 150 is located rightward of the right surface 210 of the first wall 21 in the main scanning direction, i.e., the left-right direction. The lower end 154 of the right wall 155 of the lid 150 abuts the end portion 211 of the first wall 21.

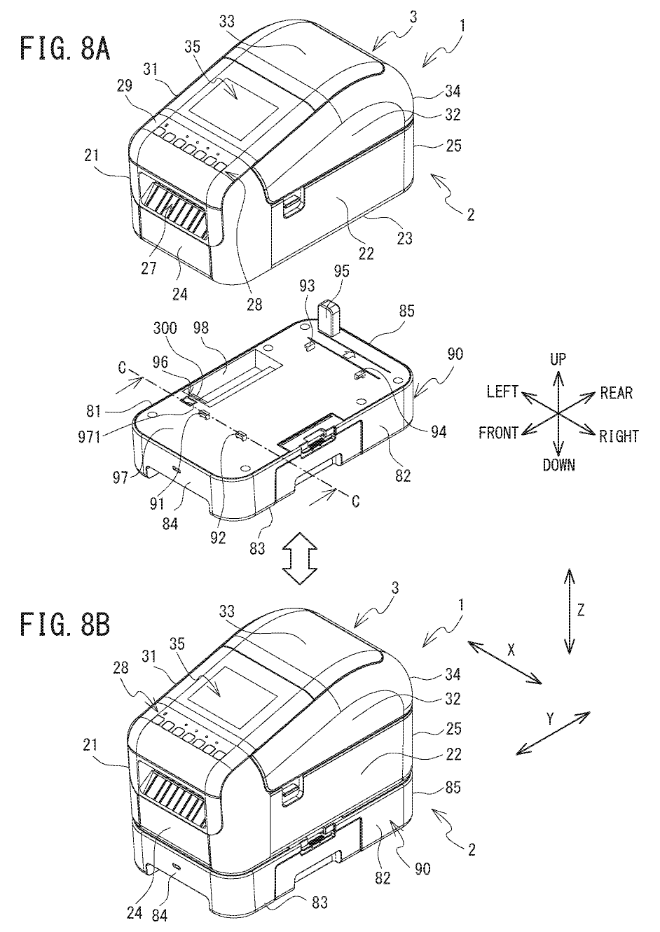

A battery base 90 that is attachable to the printer 1 and the printer 201 is described with reference to FIGS. 8A to 11. Specifically, an embodiment is described in which the battery base 90 is attached to the printer 1, as an example.

As shown in FIGS. 8A to 11, the battery base 90 is configured to be connected or coupled to the printer 1. The battery base 90 is configured to house or accommodate a battery for supplying power to the printer 1 when battery base 90 is connected to the printer 1. The battery base 90 has a shape of a rectangular box having a left wall 81, a right wall 82, a lower wall 83, a front wall 84, a rear wall 85 and an upper wall 97. A shape of the upper wall 97 in the plan view corresponds to a shape of the lower wall 23 of the printer 1 in a bottom view. The left wall 81 includes a housing portion 840 that is recessed rightward from a left surface of the left wall 81.

As shown in FIG. 8B, the battery base 90 is connected to the printer 1 in an orientation in which the lower wall 83 of the printer 1 abuts the upper wall 97 of the battery base 90. In a case where the battery base 90 is connected to the printer 1, a left end of the left wall 81 is at the same location as a left end of the first wall 21 of the printer 1 in the main scanning direction, i.e., the left-right direction. A right end of the right wall 82 is at the same location as a right end of the second wall 22 of the printer 1 in the main scanning direction. A front end of the front wall 84 is at the same location as a front end of the front wall 24 of the printer 1 in the sub scanning direction, i.e., the front-rear direction.

The upper wall 97 of the battery base 90 includes a recess 98, hooks 91 to 94, a latch 96 and a projection 95. The battery base 90 also includes a release lever 99 and a coil spring 973 that are disposed in the housing portion 840.

The recess 98 is recessed downward at a center portion in the sub scanning direction of a left portion of the upper wall 97. The recess 98 has a rectangular shape that is elongated in the sub scanning direction in the plan view. A wire harness 300 for electrical connection with the printer 1 is disposed in the recess 98.

The hooks 91 to 94 extend upward from an upper surface of the upper wall 97. The hooks 91, 92 each have a rectangular shape that is elongated in the left-right direction in the plan view. The hooks 91, 92 are disposed frontward of the recess 98. The hooks 91, 92 are at the same location with each other in the sub scanning direction. The hook 91 is disposed leftward of the hook 92. The hooks 91, 92 each have an opening or a recess that is open frontward.

The hooks 93, 94 each have a rectangular shape that is elongated in the front-rear direction in the plan view. The hooks 93, 94 are disposed rearward of the recess 98. The hook 93 has an opening or a recess that is open frontward and leftward. The hook 94 has an opening or a recess that is open frontward and rightward. The hooks 93, 94 are at the same location with each other in the sub scanning direction. The hook 93 is disposed leftward of the hook 94. A distance between the hooks 91, 92 is shorter than a distance between the hooks 93, 94.

The latch 96 is configured to engage with the printer 1 to thereby removably secure the printer 1 to the battery base 90. The latch 96 is disposed leftward of the hook 91 and extends through a hole 971 of the upper wall 97. The latch 96 protrudes upward from an upper end of the release lever 99.

The release lever 99 is disposed in the housing portion 840. The release lever 99 includes a body 991, an operation portion 993 and a tubular portion 994. The body 991 is shaped as a box that has a recess 992 that is recessed upward and that is open downward. The latch 96 projects upward from an upper surface of the body 991. The upper surface of the body 991 opposes or faces the upper wall 97 in the perpendicular direction.

A lower right portion of the body 991 is located above a lower surface 841 of the housing portion 840. A lower left portion of the body 991 is located below the lower surface 841. The body 991 is configured to guide the release lever 99 when the release lever 99 is moved in the perpendicular direction.

The operation portion 993 projects leftward from a left surface of the body 991. The operation portion 993 extends in the sub scanning direction in the left side view. In the sub scanning direction, a left end of the operation portion 993 is approximately at the same location as a left end of the left wall 81.

The tubular portion 994 extends downward from a top center portion of the recess 992. The tubular portion 994 opposes or faces a solid cylinder portion 842 that projects upward from the lower surface 841 of the housing portion 840. The tubular portion 994 has a larger diameter than the solid cylinder portion 842. An upper end of the coil spring 973 is disposed inside the tubular portion 994. A lower end portion of the coil spring 973 is disposed around the solid cylinder portion 842.

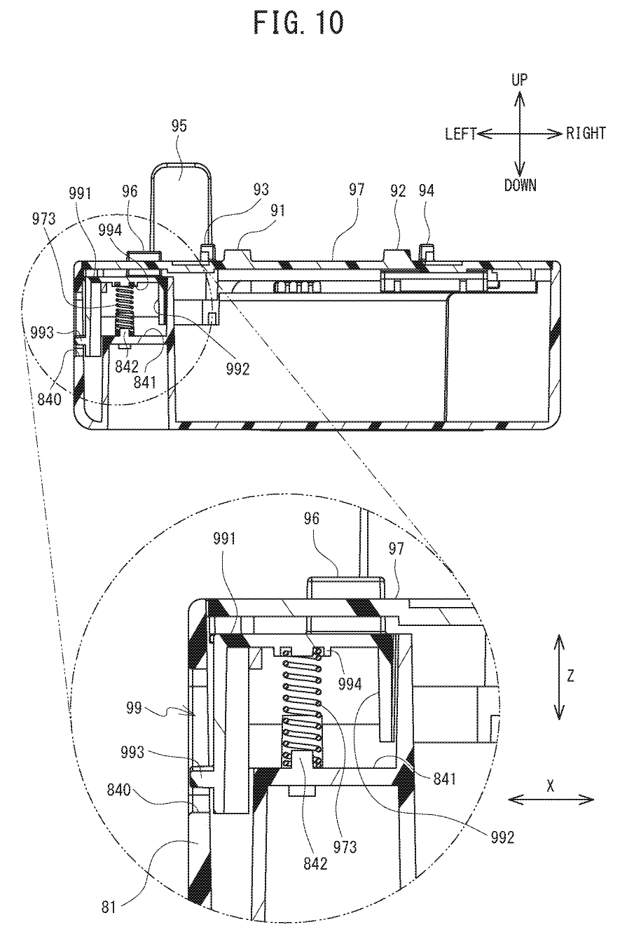

The coil spring 973 is held by the tubular portion 994 and the solid cylinder portion 842. The release lever 99 is biased upward by the coil spring 973. While the release lever 99 is not being operated, the release lever 99 is maintained at a position where the body 991 abuts a projection that projects downward from a lower surface of the upper wall 97, as shown in FIG. 10. While the release lever 99 is not being operated, an upper end of the latch 96 is located above the upper wall 97.

In a case where the release lever 99 is pressed downward, the release lever 99 moves downward against a biasing force of the coil spring 973 until the body 991 abuts the lower surface 841 of the housing portion 840. In a case where the body 991 abuts the lower surface 841 of the housing portion 840, the upper end of the latch 96 is located below the upper surface of the upper wall 97.

The projection 95 extends upward from a left rear portion of the upper wall 97 of the battery base 90. In a case where the battery base 90 is connected to the printer 1, the projection 95 is disposed within a recess 340 of the rear wall 25 of the printer 1. The projection 95 is disposed directly behind the DC port 341 that is disposed in the recess 340. The projection 95 thus serves to prevent the AC adapter from being connected to the DC port 341 while the printer 1 is connected to the battery base 90.

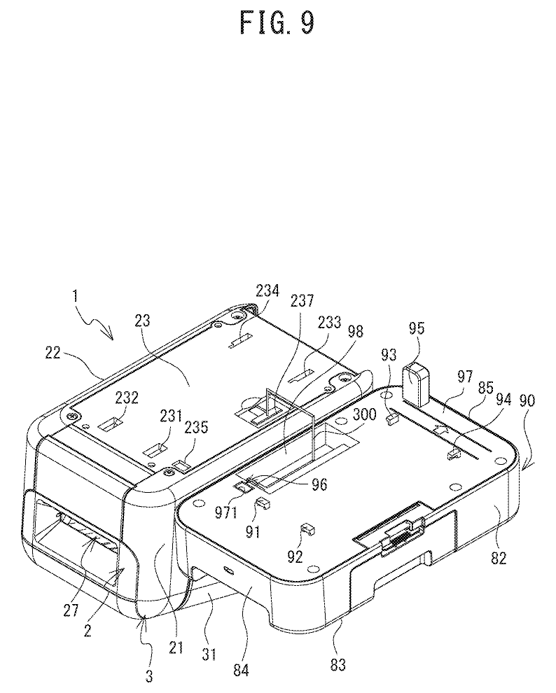

In a case where the user attaches the printer 1 to the battery base 90, the user places the printer 1 and the battery base 90 side by side, with the lower wall 23 of the printer 1 facing upward, as shown in FIG. 9. The lower wall 23 of the printer 1 includes recesses 231 to 235 and a connector 237. The connector 237 is normally covered by a connector cover. The user releases a lock of the connector cover and removes the connector cover from the lower wall 23, so that the connector 237 is exposed to an outside. The recesses 231 to 235 are recessed upward from a lower surface of the lower wall 23. The user inserts an end of the wire harness 300 extending from the recess 98 into the connector 237 of the printer 1.

The user then holds the printer 1 above the battery base 90 with the lower wall 23 facing downward, as shown in FIG. 8A. The user moves the printer 1 downward, positions the printer 1 such that a front end of the printer 1 is slightly frontward of a front end of the battery base 90, and engages the hooks 91 to 94 with the recesses 231 to 234.

Specifically, the hook 91 is inserted in the recess 231. The hook 92 is inserted in the recess 232. The hook 93 is inserted in the recess 233. The hook 94 is inserted in the recess 234. During this process, the lower wall 23 comes into contact with the latch 96 and moves the latch 96 downward.

The recesses 231, 232 are slightly longer than the hooks 91, 92 in the main scanning direction. The recesses 233, 234 are longer than the hooks 93, 94 in the main scanning direction. Therefore, when the recesses 231 to 234 are respectively engaged with the hooks 91 to 94, movement of the printer 1 in the main scanning direction relative to the battery base 90 is restricted.

The recesses 231, 232 are longer than the hooks 91, 92 in the sub scanning direction. The recesses 233, 234 are longer than the hooks 93, 94 in the sub scanning direction. Therefore, when the recesses 231 to 234 are respectively engaged with the hooks 91 to 94, the printer 1 is movable in the sub scanning direction relative to the battery base 90. In a case where the recesses 231 to 234 are respectively engaged with the hooks 91 to 94, the printer 1 is also upwardly movable relative to the battery base 90.

The user moves the printer 1 rearward relative to the battery base 90, with the recesses 231 to 234 being respectively engaged with the hooks 91 to 94 and with the lower wall 23 of the printer 1 being in abutment with the upper wall 97 of the battery base 90. In a case where the printer 1 reaches a position where the latch 96 faces the recess 235, the latch 96 moves upward into the recess 235, owing to the biasing force of the coil spring 973. The latch 96 thus engages with the recess 235 to restrict the movement of the printer 1 in the main scanning direction and the sub scanning direction relative to the battery base 90. The hooks 91 to 94 engage with the lower wall 23 to restrict the movement of the printer 1 in the main scanning direction, the sub scanning direction, and the perpendicular direction relative to the battery base 90. Through the above-described operations, the printer 1 is attached or connected to the battery base 90 as shown in FIGS. 8B and 11.

In a case where the user disconnects or separates the printer 1 from the battery base 90, the user presses the operation portion 993 of the release lever 99 downward to move the release lever 99 downward. The latch 96 moves downward, against the biasing force of the coil spring 973, to a location below the upper surface of the upper wall 97. The user moves the printer 1 forward relative to the battery base 90 while pressing the release lever 99 to maintain the latch 96 below the upper surface of the upper wall 97. In response to the forward movement of the printer 1, the hooks 91 to 94 are disengaged from the lower wall 23, so that the printer 1 can be moved upward relative to the battery base 90. The user then moves the printer 1 upward relative to the battery base 90 and disconnect the wire harness 300 from the connector 237.

In the embodiments described above, the printers 1, 201 are examples of a printer according to the present disclosure. The housing 2 is an example of a housing according to the present disclosure. The cover 3 is an example of a cover according to the present disclosure. The holder 5 is an example of a holder according to the present disclosure. The battery housing portions 6, 106 are examples of a battery housing portion according to the present disclosure. The coin cell battery 7 is an example of a coin cell battery according to the present disclosure. The pivot shaft 20 is an example of a pivot shaft according to the present disclosure. The first wall 21 is an example of a first wall according to the present disclosure. The second wall 22 is an example of a second wall according to the present disclosure. The lower wall 23 is an example of a lower wall according to the present disclosure. The opposing surface 26 is an example of an opposing surface according to the present disclosure.

The print head 30 is an example of a print head according to the present disclosure. The housing space 40 is an example of a housing space according to the present disclosure. The projection 41 is an example of a projection according to the present disclosure. The lids 51, 150 are examples of a lid according to the present disclosure. The arms 52, 53 are examples of an arm according to the present disclosure. The lock portion 55 is an example of a lock portion according to the present disclosure. The unlock portion 56 is an example of an unlock portion according to the present disclosure. The grooves 161, 162 are examples of a groove according to the present disclosure. The virtual axis J is an example of a virtual axis according to the present disclosure. The print medium R is an example of a print medium according to the present disclosure.

The printer 1 in the above-described embodiment includes the print head 30, the housing 2, and the battery housing portion 6. The print head 30 extends in the main scanning direction. The housing 2 includes the first wall 21, the second wall 22 and the lower wall 23. The first wall 21 extends in the direction that crosses the main scanning direction. The second wall 22 opposes or faces the first wall 21. The lower wall 23 connects the first wall 21 and the second wall 22 with each other in the main scanning direction. The housing 2 includes the housing space 40 between first wall 21 and the second wall 22. The housing space 40 is configured to house or accommodate the print medium R. The battery housing portion 6 is included in the first wall 21. The battery housing portion 6 is configured to house or accommodate the battery 7.

The first wall 21 of the printer 1 includes the battery housing portion 6. The first wall 21 is more easily accessible for the user than the lower wall 23. Therefore, the printer 1 contributes to easier replacement of the battery 7 with simple operations of the user, as compared to a known printer with a lower wall having a battery housing portion.

The printer 1 includes the cover 3 and the holder 5. The cover 3 is supported by or on the housing 2 to be pivotable to the closed position and the open position. The cover 3 at the closed position closes the housing space 40. The cover 3 at the open position opens the housing space 40. The holder 5 is configured to removably hold the battery 7. The first wall 21 has the opposing surface 26 that opposes or faces the cover 3 that is disposed at the closed position. The battery housing portion 6 is a recess in the opposing surface 26. The recess is configured to house or accommodate the holder 5 to be slidable in the perpendicular direction, which is perpendicular to the opposing surface 26.

The printer 1 contributes to easier access of the user to the battery housing portion 6, as compared to another printer that includes the battery housing portion 6 in a surface different from the opposing surface 26. For example, the different surface may be a surface of the first wall 21 that opposes or faces the second wall 22, or a surface of the first wall 21 that is on the opposite side of the first wall 21 from the surface that opposes the second wall 22. The holder 5 of the printer 1 facilitates attachment or removal of the battery 7 to or from the battery housing portion 6, as compared to another printer that includes a battery housing portion that is configured to directly receive the battery 7, i.e., without a holder of the battery 7.

The holder 5 of the printer 1 includes the lid 51 and the arms 52, 53. The shape of the holder 5 is asymmetric with respect to the virtual axis J that passes the center of the lid 51 and extends in the perpendicular direction. The lid 51 closes the battery housing portion 6 with the holder 5 housed in the battery housing portion 6. The arms 52, 53 are connected to the lid 51. The arms 52, 53 are configured to hold the battery 7 in the predetermined orientation in which the electric terminal surfaces 71, 72 are perpendicular to the main scanning direction. The battery housing portion 6 is a recess that has a shape conforming to the holder 5 in the first orientation. The battery housing portion 6 is configured to support the holder 5 that is disposed in the battery housing portion 6, i.e., the recess, in the first orientation such that the holder 5 is slidable in the perpendicular direction. Further, the battery housing portion 6, i.e., the recess, is configured to interfere with the holder 5 in the second orientation, in which the holder is 180 degrees rotated from the first orientation about the virtual axis J, to thereby prevent insertion of the holder 5 in the battery housing portion 6.

The battery housing portion 6 of the printer 1 serves to reduce a possibility of erroneous attachment of the battery 7 with the electric terminal surfaces 71, 72 facing wrong directions, by utilizing a relatively simple structure.

The cover 3 of the printer 1 is supported at one of the end portions 45, 46 in the sub scanning direction of the housing 2, specifically, at the rear end portion 46, to be pivotable about the pivot shaft 20 extending in the main scanning direction. The sub scanning direction is perpendicular to the main scanning direction and the perpendicular direction. The holder 5 includes the lid 51 and arms 52, 53. The lid 51 closes the battery housing portion 6 with the holder 5 housed in the battery housing portion 6. The arms 52, 53 are connected to the lid 51 and configured to hold the battery 7. The printer 1 includes the lock portion 55 and the unlock portion 56. The lock portion 55 is configured to restrict movement, in the perpendicular direction, of the holder 5 housed in the battery housing portion 6, i.e., a recess. The unlock portion 56 is disposed between the pivot shaft 20 and the virtual axis J in the sub scanning direction. The virtual axis J passes the center of the lid 51 and extends in the perpendicular direction. The unlock portion 56 is configured to release or unlock the holder 5 locked by the lock portion 55.

In a case where the user loads the print medium R into the housing space 40 of the printer 1, the user handles the print medium R from a front side of the housing 2, that is, a side opposite from the pivot shaft 20, i.e., the rear end portion of the housing 2, in the sub scanning direction. Therefore, the unlock portion 56 of the printer 1 is less likely to be accidentally operated by the user while loading the print medium R, as compared to another printer that includes the unlock portion 56 that is disposed on the opposite side from the pivot shaft 20 with respect to the virtual axis J, i.e., at the front side of the virtual axis J.

The printer 1 includes the projection 41 that is disposed between the unlock portion 56 and the pivot shaft 20 in the sub scanning direction. The projection 41 projects further from the opposing surface 26 than the unlock portion 56 in the perpendicular direction. The projection 41 of the printer 1 serves to reduce a possibility that the unlock portion 56 is accidentally operated by the user while loading the print medium R into the housing space 40, as compared to another printer in which the projection 41 is not disposed between the unlock portion 56 and the pivot shaft 20 in the sub scanning direction.

The printer 201 according to the modified embodiment includes the cover 3. The cover 3 is supported by or on the housing 2 to be pivotable to the closed position and the open position. The cover 3 at the closed position closes the housing space 40. The cover 3 at the open position opens the housing space 40. The first wall 21 has the opposing surface 26 that opposes or faces the cover 3 that is disposed at the closed position. The battery housing portion 106 is a recess in the opposing surface 26. The battery housing portion 106, i.e., the recess, has the grooves 161, 162. The grooves 161, 162 are configured to support the battery 7 in the orientation in which the electric terminal surfaces 71, 72 are perpendicular to the main scanning direction such that the battery 7 is slidable in the perpendicular direction, which is perpendicular to the opposing surface 26.

The battery housing portion 106 of the printer 201 is more easily accessible for the user, as compared to another printer that includes the battery housing portion 106 in a surface different from the opposing surface 26. For example, the different surface may be a surface of the first wall 21 that opposes or faces the second wall 22, or a surface of the first wall 21 that is on the opposite side of the first wall 21 from the surface that opposes the second wall 22. The grooves 161, 162 of the printer 201 serve to guide the movement of the battery 7 in the perpendicular direction.

The printer 201 includes the lid 150 that is configured to close the battery housing portion 106 with the battery 7 housed in the battery housing portion 106. The lid 150 of the printer 201 serves to reduce entry of dust into the battery housing portion 106, as compared to another printer that does not include the lid 150.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

The cover 3 may be omitted from the printer 1 or the printer 201. The first wall 21 may be a left wall or a right wall of the housing 2 of the printer 1 or the printer 201, as long as the first wall 21 includes the battery housing portion 6 or the battery housing portion 106. The battery housing portion 6 or the battery housing portion 106 may be a recess that is recessed downward from the opposing surface 26. Alternatively, the battery housing portion 6 or the battery housing portion 106 may be a recess that is disposed in one of two opposite surfaces of the first wall 21 that are perpendicular to the main scanning direction and that is recessed toward the other of the two opposite surfaces.

The orientation of the electric terminal surfaces 71, 72 may be changed as appropriate. For example, the battery housing portion 6 or the battery housing portion 106 may be configured to house the battery 7 such that the electric terminal surfaces 71, 72 of the battery 7 are perpendicular to the sub scanning direction or the perpendicular direction.

The holder 5 may be omitted from the printer 1. The printer 1 without the holder 5 may include a biasing member, a flat spring, for example, that is disposed in the battery housing portion 6, i.e., a recess, such that the battery 7 is held by the biasing member and the battery housing portion 6.

The structure of the holder 5 may be modified as appropriate. For example, the arms 52, 53 may extend in the sub scanning direction. In order to attach the battery 7 to the holder 5 with the arms 52, 53 extending in the sub scanning direction, the user of the printer 1 may move the battery 7 in the sub scanning direction or the main scanning direction relative to the holder 5. The lid 51 of the holder 5 may be arranged so as not to close the battery housing portion 6. One or more of the lid 51 and arms 52, 53 may be omitted from the holder 5. In the perpendicular direction, i.e., the up-down direction, the upper surface of the lid 51 may be at a different location, i.e., at a different height level, from the opposing surface 26 when the holder 5 is attached to the battery housing portion 6.

The cover 3 may be arranged so as not to be supported to be pivotable to the closed position at which the cover 3 covers the housing space 40 and the open position at which the cover 3 opens the housing space 40. The cover 3 may be removable from the housing 2. The opposing surface 26 may be a curved surface. The battery housing portion 6 may be configured to house the holder 5 such that the holder 5 is slidable in the sub-scanning direction. The cover 3 may be supported at one of opposite end portions in the main scanning direction of the housing 2, i.e., at a left end portion or a right end portion of the housing 2, to be pivotable about a pivot shaft that extends in the sub scanning direction, i.e., the front-rear direction. The pivot shaft 20 may be positioned in the cover 3 and may be a protrusion that engages with a recess in the housing 2. The pivot shaft 20 may be positioned in the housing 2 and may be a protrusion that engages with a recess in the cover 3.

The holder 5 may be symmetric with respect to the virtual axis J that passes the center of the lid 51 and extends in the perpendicular direction. The lock portion 55 and the unlock portion 56 may be omitted from the printer 1. The structures of the lock portion 55 and the unlock portion 56 may be modified as appropriate. The first wall 21 may include both the lock portion 55 and the unlock portion 56. The first wall 21 may include the lock portion 55 or the unlock portion 56. The lid 51 of the printer 1 may be disposed between the unlock portion 56 and the pivot shaft 20 in the sub scanning direction.

The projections 41, 42 may be omitted from the printer 1. The projection 41 may be disposed so as not to protrude further from the opposing surface 26 than the unlock portion 56 in the perpendicular direction. The projection 41 may omit the hole 410. The wire protection portion 37 may be arranged so as not to be disposed in the hole 410.

The structures of the battery housing portion 106 of the printer 201 in the modified embodiment may be modified as appropriate. The grooves 161, 162 may face each other in the main scanning direction. The battery housing portion 106 may be located leftward of the medium support portion 43 of the first wall 21.

The lid 150 of the printer 201 may be omitted. The structures of the lid 150 may be modified as appropriate. The lid 150 may be arranged so as not to close the battery housing portion 106. The lid 150 attached to the battery housing portion 106 may not be in contact with or abut the battery 7. The printer 201 may include another member that is different or discrete from the lid 150 and configured to define a position of the battery 7 in the perpendicular direction or the main scanning direction.

The printer 1 or the printer 201 may be incapable of being attached to the battery base 90. The lower wall 23 of the printer 1 or the printer 201 that is not attachable or connectable to the battery base 90 may not include the recesses 231 to 235 and the connector 237. The structures of the battery base 90 may be modified as appropriate. The numbers, shapes, and positions of the hooks and the latch of the battery base 90 may be modified as appropriate. A method of attaching or connecting the printer 1 or the printer 201 to the battery base 90 may be modified as appropriate. The battery base 90 may omit a mechanism, a latch, for example, for securing the printer 1. The projection 95 may be omitted or removable from the battery base 90.

The above-described embodiment and modified examples may be combined as appropriate insofar as no contradictions arise. In addition to combinations exemplified in the scope of the claims herein, the applicants of the present application have an intention to acquire the patent rights for other combined aspects insofar as they do not depart from the scope and gist of the present disclosure, and insofar as no contradictions arise.

What is claimed is:

1. A printer comprising:
a print head extending in a main scanning direction;
a housing including (i) a first wall extending in a direction that crosses the main scanning direction, (ii) a second wall opposing the first wall, (iii) a lower wall connecting the first wall and the second wall with each other in the main scanning direction, and (iv) a housing space defined between the first wall and the second wall and configured to house a print medium; and
a battery housing portion included in the first wall of the housing and configured to house a coin cell battery.

2. The printer according to claim 1, further comprising:
a cover supported by the housing to be pivotable to (i) a closed position at which the cover closes the housing space and (ii) an open position at which the cover opens the housing space; and
a holder configured to removably hold the coin cell battery,
wherein
the first wall includes an opposing surface that opposes the cover disposed at the closed position, and
the battery housing portion is a recess in the opposing surface and configured to house the holder to be slidable in a perpendicular direction that is perpendicular to the opposing surface.

3. The printer according to claim 2, wherein
the holder includes:
a lid configured to close the battery housing portion with the holder housed in the battery housing portion; and
an arm connected to the lid and configured to hold the coin cell battery in an orientation in which an electric terminal surface of the coin cell battery is perpendicular to the main scanning direction,
the holder is asymmetric with respect to a virtual axis that passes a center of the lid and extends in the perpendicular direction,
the battery housing portion disposed as the recess has a shape conforming to the holder in a first orientation,
the recess is configured to support the holder inserted in the recess in the first orientation to be slidable in the perpendicular direction, and
when the holder is in a second orientation, in which the holder is 180 degrees rotated from the first orientation about the virtual axis, the recess interferes with the holder to prevent insertion of the holder into the recess.

4. The printer according to claim 2, further comprising:
a lock portion configured to restrict movement, in the perpendicular direction, of the holder housed in the battery housing portion disposed as the recess; and
an unlock portion configured to release the holder locked by the lock portion,
wherein
the cover is supported at one of opposite end portions of the housing in a sub scanning direction, which is perpendicular to the main scanning direction and the perpendicular direction, such that the cover is pivotable about a pivot shaft extending in the main scanning direction,
the holder includes:
a lid configured to close the battery housing portion with the holder disposed in the battery housing portion; and
an arm connected to the lid and configured to hold the coin cell battery, and
the unlock portion is disposed between the pivot shaft and a virtual axis in the sub scanning direction, the virtual axis passing a center of the lid and extends in the perpendicular direction.

5. The printer according to claim 4, further comprising:
a projection disposed between the unlock portion and the pivot shaft in the sub scanning direction, the projection projecting further from the opposing surface than the unlock portion in the perpendicular direction.

6. The printer according to claim 1, further comprising:
a cover supported by the housing to be pivotable to (i) a closed position at which the cover closes the housing space and (ii) an open position at which the cover opens the housing space, wherein
the first wall includes an opposing surface that opposes the cover disposed at the closed position,
the battery housing portion is a recess in the opposing surface, and
the recess has a groove configured to support the coin cell battery in a predetermined orientation to be slidable in a perpendicular direction that is perpendicular to the opposing surface, an electric terminal surface of the coin cell battery in the predetermined orientation being perpendicular to the main scanning direction.

7. The printer according to claim 1, further comprising a lid configured to close the battery housing portion with the coin cell battery housed in the battery housing portion.
